(19) United States
(12) Patent Application Publication
(10) Pub. No.: US 2011/0092614 A1
(43) Pub. Date: Apr. 21, 2011

(54) APPLICATIONS OF ETHYLENE/TERAFLUOROETHYLENE COPOLYMER

(75) Inventors: Ralph Munson Aten, Chadds Ford, PA (US); Heidi Elizabeth Burch, Parkersburg, WV (US); Sharon Ann Libert, Hockessin, DE (US)

(73) Assignee: E. I. DUPONT DENEMOURS AND COMPANY

(21) Appl. No.: 12/999,405

(22) PCT Filed: Jun. 25, 2009
(86) PCT No.: PCT/US09/48601

§ 371 Date: Dec. 16, 2010

Related U.S. Application Data
(60) Provisional application No. 61/079,503, filed on Jul. 10, 2008.

(51) Int. Cl. C08L 27/18

(52) U.S. Cl. 523/201; 525/199

(57) ABSTRACT

Ethylene/fluoroethylene copolymer of improved non-flammability as characterized by limiting oxygen index is provided in the form of core/shall polymer, the core being non-melt flowable polytetrafluoroethylene and the shell being said copolymer and comprising at least about 72 wt % of the combined weight of the polytetrafluoroethylene core and the copolymer shell.

### BACKGROUND OF THE INVENTION

1. Field of the Invention

This invention relates to new applications of ethylene/tetrafluoroethylene copolymer and its new association with polytetrafluoroethylene.

2. Description of Related Art

Melt-fabricable perfluoropolymers and ethylene/tetrafluoroethylene copolymer (ETFE) have different properties, some of which make themselves useful in certain applications, and some of which are disadvantageous. The melt-fabricable perfluoropolymers, notably copolymers of tetrafluoroethylene (TFE) with either hexafluoropropylene (HFP), commonly called FEP, or perfluoro(alkyl vinyl ether) (PAVE) such as perfluoro(ethyl or propyl vinyl ether), such copolymers being commonly called PFA, melt at about 260° C. and 310° C., respectively, and have a use temperature of 200° C. and 260° C., respectively. These copolymers have a limiting oxygen index (LOI) of at least 95, which means they are highly non-flammable by virtue of requiring the oxygen content of the oxygen/nitrogen atmosphere within which test combustion is carried out to be at least 95% to support combustion of the copolymer. This high LOI contributes to the ability to use these copolymers at their respective high use temperatures. These copolymers are also characterized by high flexibility characterized by low flex modulus, e.g. about 650 to 690 MPa (94000 to 100,000 psi). A disadvantage of this low flex modulus that special precautions are required in the use of articles melt-fabricated from the perfluoropolymer for structural applications. For example, pipe made from the perfluoropolymer has to be supported at close distances to compensate for the tendency of the pipe to sag under its own weight. Some stiffening is achieved by making the pipe wall thicker, which has the disadvantage of increasing the cost of the fabricated article. It is known to blend fiber material into melt-fabricable perfluoropolymers to increase flex modulus, but the problem with these additives is that are chemically dissimilar to the perfluoropolymer matrix and either are more reactive than the perfluoropolymer matrix to process fluids coming into contact with the perfluoropolymer article or have the tendency to become dislodged from the surface of the perfluoropolymer article to contaminate the process fluid or both.

Melt fabricable copolymers of ethylene with tetrafluoroethylene (ETFE), typically having an ethylene content of 50 mol %, have been developed, which have a melt temperature of about 270° C. While this melt temperature is higher than that of TFE/HFP copolymer, the use temperature of ETFE is much lower, i.e. 150° C. The use temperature of ETFE is so low because of its flammability, i.e. having an LOI of only about 30. This means that in the nitrogen/oxygen atmosphere within which the ETFE article is subjected to burning, as little as 30% oxygen concentration supports combustion of the ETFE article. In applications requiring higher tensile strength than the 20-30 MPa exhibited by melt-fabricable perfluoropolymers, ETFE has been used. This copolymer also exhibits an elongation of at least 300%, which is high as the elongation of melt-fabricable perfluoropolymers. The ETFE is also a stiffer copolymer than FEP and PFA, exhibiting a flex modulus in excess of 1150 MPa. In a major application of ETFE, as insulation for electrical cable in airplane wiring, the high flex modulus of ETFE is a disadvantage, in resisting the bending of the ETFE-insulated cable in installation within the airplane.

There is a need for a more flexible ETFE and a stiffer melt-fabricable perfluoropolymer, especially FEP and PFA.

### SUMMARY OF THE INVENTION

The present invention satisfies these needs and in the course of doing so, provides a novel ETFE.

With respect to providing the desired effect on ETFE and melt-fabricable perfluoropolymer, the present invention is a composition comprising a matrix of either (a) ethylene/tetrafluoroethylene copolymer (ETFE) or (b) melt-fabricable perfluoropolymer, each containing submicrometer-size particles of polytetrafluoroetheylene (PTFE) therein, with the proviso that ethylene/tetrafluoroethylene copolymer is also contained in perfluoropolymer (b). The amounts of the additive in the composition containing copolymer (a) is preferably that which is effective for the composition to exhibiting an decrease in flex modulus of at least 20% as compared to said copolymer by itself. The amount of the additive in the composition containing perfluoropolymer (b) is preferably that which is effective for the composition to exhibit an increase in flex modulus of at least 20% as compared to said perfluoropolymer by itself.

In the preferred preparation of the above composition containing, the ETFE, the PTFE particles are accompanied by ETFE, whereby this composition will additionally contain ETFE. In one embodiment, the PTFE particles are coated with the accompanying ETFE, and the melt mixing of this combination of PTFE and ETFE with the ETFE forming the matrix of the composition provides the composition of ETFE from both the matrix copolymer and the ETFE from the coating, within which the submicrometer-size PTFE particles are dispersed.

Preferably, the PTFE particles coated with ETFE are core/shell polymer particles wherein the core is said PTFE and the shell is said ETFE. The shell, in effect, is a coating of ETFE on the PTFE particle core. Alternatively, the melt mixing is carried out with the PTFE particles being dispersed within the accompanying ETFE, whereby the resultant ETFE matrix forms the coating on the PTFE particles. This embodiment can be obtained by melt mixing the core/shell polymer, wherein the ETFE shell loses its particulate identity and becomes the matrix for the PTFE core as PTFE particles dispersed within the matrix. Thus, according to this embodiment, particulate ETFE in the form of extruded pellets of the PTFE particle/ETFE matrix blend are melt mixed with ETFE matrix copolymer, typically also in melt-extruded pellet form to form the composition containing ETFE (a). This approach can be used to form the composition containing the perfluoropolymer (b).

In the composition containing copolymer (a), the amount of said polytetrafluoroethylene is preferably 0.5 to 10 wt % based on the combined weight of said polytetrafluoroethylene and copolymer (a). In the composition of containing perfluoropolymer (b), the combined amount of ETFE and particles of polytetrafluoroethylene is preferably 10 to 30 wt %, based on the combined weight of said perfluoropolymer, ETFE and PTFE.

The present invention also is a process comprising blending submicrometer-size particles of polytetrafluoroethethylene either into ETFE to reduce the stiffness thereof or together with ETFE into melt-fabricable perfluoropolymer to increase the stiffness thereof. As described above the particles of polytetrafluoroethylene blended into said ETFE to reduce its stiffness are preferably contained within particulate ETFE, whereby the PTFE particles are coated with the ETFE. Preferably, the particles of PTFE are the cores of core/shell polymer, i.e. the core comprises the PTFE and the shell comprising the ETFE. These preferences also apply to the stiffening of the perfuoropolymer. As in the composition aspect of the present invention, the reduction in stiffness of the ETFE is preferably characterized by a reduction in flex modulus of at least 20%, and the increase in flex modulus of the perfuoropolymer is at least 20%, as described above.

Another embodiment of the present invention is the ethylene/tetrafluoroethylene copolymer (ETFE) in the form of core/shell polymer, the core being polytetrafluoroethylene and the shell being the ETFE. This is a new composition of ETFE, and this new composition exhibits surprisingly high LOI, enabling its use temperature to be increased.

One form of the core/shell polymer is the aqueous dispersion within which the polymer is formed by polymerization as will be discussed hereinafter, and wherein the core/shell polymer average particle size is no greater than 125 nm, preferably no greater than 100 nm. The core/shell polymer can have other forms, such as the coagulate formed from coagulating the dispersion core/shell polymer particles, i.e. a coagulate of the primary particles. This coagulate can be dried to form agglomerates (secondary particles) of primary particles and in this way, the primary particles can be exposed to melt mixing, such as in an extruder, to form extruded pellets. Any of these core/shell and melt mixture forms can be used to form the compositions and to practice the process of the present invention. The resultant melt mixture comprises a dispersion of the PTFE core as submicrometer-size particles in a matrix of ETFE.

In all the embodiments of the present invention, the submicrometer-size PTFE particles, whether present as the core of core/shell polymer or otherwise, is non-melt flowable. In the core/shell polymers prepared in the Examples, the PTFE core is non-melt flowable.

The fluoropolymers making up the core/shell polymer, whether the ETFE is the shell of the core/shell polymer or the matrix for dispersed PTFE particles, have chemical inertness similar to the melt-fabricable perfluoropolymer, and as compared to non-fluoropolymer additives, have a lesser tendency to become dislodged from the surface of articles melt-fabricated from the blend.

### DETAILED DESCRIPTION

In this detailed description, the core/shell polymer will first be described, followed by description of the stiffening of melt-fabricable perfluoropolymer and the reduction in stiffness of the ETFE matrix polymers.

The PTFE core of the core/shell polymer is formed by conventional aqueous dispersion polymerization of TFE to form the fine powder type of PTFE. The fine powder type of PTFE has such a high molecular weight, e.g. at least 1,000,000, that it does not flow in the molten state. Such PTFE is also fibrillatable when subjected to shear. If the polymerization of TFE is stopped after making the dispersed PTFE particles that form the core of the core/shell polymer and the resultant PTFE is isolated and tested for flow property, such as by the test procedure of ASTM D 1238-94a involving the forcing (5 kg weight) of molten polymer through an orifice, the molten PTFE at 380° C. does not flow through the orifice. Such PTFE also has a high melt creep viscosity, sometimes called specific melt viscosity, which involves the measurement of the rate of elongation of a molten sliver of PTFE under a known tensile stress for 30 min, as further described in and determined in accordance with U.S. Pat. No. 6,841,594, referring to the specific melt viscosity measurement procedure of U.S. Pat. No. 3,819,594. In this test, the molten sliver made in accordance with the test procedure is maintained under load for 30 min, before the measurement of melt creep viscosity is begun, and this measurement is then made during the next 30 min of applied load. The PTFE preferably has a melt creep viscosity of at least about 1×10⁶ Pa.s, more preferably at least about 1×10⁷ Pa.s, and most preferably at least about 1×10⁸ Pa.s, all at 380° C. This temperature is well above the first and second melt temperatures of PTFE of 343° C. and 327° C., respectively.

The PTFE from which the core is made can be homopolymer of tetrafluoroethylene or a copolymer thereof with a small amount of comonomer, such as hexafluoropropylene or perfluoro(alkyl vinyl ether) (PAVE) wherein the alkyl group can be linear or branched and contains 1 to 5 carbon atoms, that improves the sinterability of the TFE, to obtain such improvement as reduced permeability and greater flex life, as compared to the TFE homopolymer. The comonomer-modified PTFE is sometimes referred to simply as modified PTFE. Examples of modified PTFE are disclosed in U.S. Pat. Nos. 3,142,665, 3,819,594, and 6,870,020 and this modified PTFE can be used as the core of the core/shell polymer of the present invention. The '665 and '594 patents disclose the very small modifier contents in the PTFE, within the range of 0.05 to 0.3 wt %, and the '020 patent discloses higher modifier contents of about 0.5 to 10 wt %. For simplicity and because the modified PTFE exhibits the same non-melt flow, high melt creep viscosity of PTFE homopolymer, this type of PTFE is included in the term polytetrafluoroethylene or PTFE used herein.

The PTFE core is coated by ethylene/tetrafluorofluoroethylene copolymer by copolymerization about (onto) the core to form a shell of the copolymer about the core. The copolymers of ethylene with TFE typically contain 40 to 60 mol % of each monomer, to total 100 mol %, and preferably containing additional copolymerized monomer such as perfluoroalkyl ethylene, preferably perfluorobutyl ethylene. While ETFE is primarily composed of ethylene and TFE repeat units making up the polymer chain, it is preferred that the copolymerization is carried out with a telogenically inactive copolymerizable vinyl monomer which provides a side chain in the ethylene/fluoroethylene copolymer, containing at least one carbon atom, preferably at least two carbon atoms, for the purpose of improving properties of the copolymer such as reduced high temperature brittleness. Examples of additional monomers include perfluoroalkyl ethylene, such as perfluorobutyl ethylene, perfluoro(ethyl or propyl vinyl ether), hexafluoroisobutylene, and CH₂═CFR_{f} wherein R_{f} is C₂-C₁₀ fluoroalkyl, such as CH₂═CFC₅F₁₀H, hexafluoropropylene, and vinylidene fluoride. Typically, the additional monomer will be present in 0.1 to 10 mol % based on the total moles of TFE and ethylene. Such copolymers are further described in U.S. Pat. Nos. 3,624,250, 4,123,602, 4,513,129, and 4,677,175.

The aqueous dispersion polymerization used to form the core and shell of the polymer of the present invention uses free radical initiator to cause the polymerization to occur and surfactant to disperse the polymer particles as they are formed in the aqueous medium. The initiator used to form the PTFE core will generally also be used to form the copolymer shell. Examples of initiators used in both polymerizations are the acids and salts of manganese, such as disclosed in U.S. Pat. No. 3,859,262, such as the alkali metal and alkaline earth metal salts of permanganic acid. Examples of such salts are potassium permanganate and sodium permanganate. Preferably reducing agent is used in combination with this initiator, such as oxalic acid or a bisulfite such as sodium bisulfite. Examples of dispersing agents used in the aqueous dispersion polymerizations include ammonium perfluorooctanoic and perfluoroalkyl ethane sulfonic acid salts, such as the ammonium salt. The concentration of surfactant in the aqueous medium is typically less than 0.4 wt % based on the weight of the aqueous medium. The copolymerization step of the process is preferably carried out in the presence of chain transfer agent (CTA) in the aqueous medium, such as an alkane, such as ethane.

A general aqueous dispersion polymerization process that can be used to make the core/shell polymer of the present invention involves the steps of precharging an aqueous medium to a stirred autoclave, deoxygenating the autoclave, pressurizing with TFE to a predetermined level, adding modifying comonomer if desired, agitating, bringing the system to desired temperature, e.g., 60°-100° C., introducing initiator, adding more TFE according to predetermined basis depending on the core content in the core/shell polymer desired, and regulating temperature. Initiator addition, at the same or different rate, can be throughout the batch or only for part of the batch. Recipe and operating parameters not fixed by the equipment are commonly selected in order that temperature is maintained approximately constant throughout the polymerization. This same general procedure is followed for copolymerizing the ethylene and TFE monomers to make the copolymer shell, except that the polymerization temperature and order of addition of the ethylene, the TFE, and the additional vinyl monomer will depend on the identity of the the vinyl monomer. The transition between the polymerization to make the core and the copolymerization to make the shell can be as shown in the Examples. The timing of the transition is set in order to obtain the desired weight proportion of PTFE core in the core/shell polymer. The weight % core can be determined by comparing the weight of TFE consumed in the polymerization of the core with the weight of TFE and other monomers consumed in the polymerization of the shell. Preferably, this transition is practiced by stopping the polymerization stage forming the PTFE core and then establishing the polymerization conditions for forming the copolymer shell on the core. The transition can be carried out in a separate reactor, to which the aqueous dispersion of PTFE particles is transferred to act as a seed for the copolymerization of the ETFE shell around the PTFE particles.

To retain the melt flowable characteristic of ETFE, the amount of PTFE core is limited. A preferred core/shell composition is wherein the shell comprises at least about 72 wt % of the combined weight of said PTFE core and said copolymer shell, and the PTFE core comprises at least 1 wt % of the core/shell polymer, based on the combined weight of the core and shell. The preferred 72 wt % shell content corresponds to the shell constituting at least about 78% of the volume of the core/shell polymer, the vol % being greater than the wt % by virtue of the shell polymer having a lower density than the core polymer. Preferably the amount of core will be such that the amount of shell polymer comprises 75 to 98 wt % of the combined weight of the core and copolymer shell, more preferably 85 to 98 wt %. This provides for the core/shell polymer being melt-fabricable much like that of the shell polymer by itself. This is important if the core/shell polymer will be used for melt-fabrication of articles, such as by injection molding or extrusion, essentially by itself. The high ETFE shell content is less important when the core/shell polymer is used as an additive in ETFE or perfluoropolymer matrix polymers as will be described hereinafter.

By virtue of the PTFE particles being the nuclei (copolymerization sites) for the polymer shell, the building up of the polymer particle size with formation of the copolymer on the core results in very small polymer particles, even having an average particle size of no greater than about 90 nm. TFE polymerization conditions, including the copolymerization of TFE with modifying comonomer to form a modified PTFE core, are selected to produce small PTFE particles as nuclei. One method for obtaining this polymerization result is the use of the combination of fluorosurfactants such as disclosed in U.S. Pat. No. 6,395,848, which is a mixture of (a) a fluoroalkyl acid (carboxylic or sulfonic) or salt, such as ammonium perfluorooctanoate and (b) a perfluoropolyether acid (carboxylic or sulfonic) or salt such as the PFPE-1 to -7 disclosed in Table 1 (col. 13) of the patent. Preferably, the amount of (a) is less than 5 wt % of the combined weight of (a) and (b).

The surfactant present in the aqueous medium maintains a stable dispersion of the polymer particles until the polymerization reaction is completed to obtain the solids content in the aqueous medium desired. Preferably the polymer particles constitute at least about 15 wt %, more preferably at least about 20 wt % of the combined weight of the aqueous medium and the core/shell polymer particles. The dispersed core/shell polymer particles can be intentionally coagulated, by such conventional means as increased agitation from the agitation applied during polymerization or by addition of electrolyte. Alternatively, the coagulation can be done by freeze/thaw method such as disclosed in U.S. Pat. No. 5,708,131 (Morgan).

The particle size of the PTFE core will typically be no greater than 60 nm and more often no greater than 50 nm. These will be the particle size of the core particles in the copolymer matrix formed by melt mixing the core/shell polymer of the present invention and the melt mixture to form compositions (a) and (b) described above.

The process of the present invention provides ETFE that can be used in the same manner as prior ETFE. The presence of the small amount of PTFE core even though quite different chemically from the shell copolymer does not detract from the ETFE properties. The transition between polymerization to form the core and polymerization to form the shell provides intimacy between the incompatible polymers forming the core and shell.

With respect to the melt-fabricable perfluoropolymer to which the particulate ETFE is added for increase in flex modulus, as indicated by the prefix “per” in perfluoropolymer, the monovalent atoms bonded to the carbon atoms making up the perfluoropolymer are all fluorine atoms. Other atoms may be present in the polymer end groups, i.e. the groups that terminate the polymer chain. The perfluoropolymer is a perfluoroplastic, not a perfluoroelastomer.

The melt flow rate (MFR) of the perfluoropolymers used in the present invention can vary widely, depending on the application intended. Thus, MFRs for the melt-fabricable perfluoropolymer can be in the range of about 0.1 to 500 g/10 min, but will usually be preferred as about 0.5 to 100 g/10 min, and more preferably 0.5 to 50 g/10 min as measured according to ASTM D-1238-94a and following the detailed conditions disclosed in U.S. Pat. No. 4,952,630, at the temperature which is standard for the resin (see for example ASTM D 2116-91a and ASTM D 3307-93 that are applicable to the most common melt-fabricable fluoropolymers, both specifying 372° C. as the resin melt temperature in the Plastometer®). The amount of polymer extruded from the Plastometer® in a measured amount of time is reported in units of g/10 min in accordance with Table 2 of ASTM D 1238-94a.

Examples of perfluoropolymers that can be used in the present invention include the copolymers of tetrafluoroethylene (TFE) with one or more polymerizable perfluorinated comonomers, such as perfluoroolefin having 3 to 8 carbon atoms, such as hexafluoropropylene (HFP), and/or perfluoro(alkyl vinyl ether) (PAVE) in which the linear or branched alkyl group contains 1 to 5 carbon atoms. Preferred PAVE monomers include perfluoro(methyl vinyl ether) (PMVE), perfluoro(ethyl vinyl ether) (PEVE), perfluoro(propyl vinyl ether) (PPVE), and perfluoro(butyl vinyl ether) (PBVE). The copolymer can be made using several PAVE monomers, such as the TFE/perfluoro(methyl vinyl ether)/perfluoro(propyl vinyl ether) copolymer, sometimes called MFA by the manufacturer. The preferred perfluoropolymers are TFE/HFP copolymer in which the HFP content is about 5-17 wt %, more preferably TFE/HFP/PAVE such as PEVE or PPVE, wherein the HFP content is about 5-17 wt % and the PAVE content, preferably PEVE, is about 0.2 to 4 wt %, the balance being TFE, to total 100 wt % for the copolymer. The TFE/HFP copolymers, whether or not a third comonomer is present, are commonly known as FEP. TFE/PAVE copolymers, generally known as PFA, have at least about 2 wt % PAVE, including when the PAVE is PPVE or PEVE, and will typically contain about 2-15 wt % PAVE. When PAVE includes PMVE, the composition is about 0.5-13 wt % perfluoro(methyl vinyl ether) and about 0.5 to 3 wt % PPVE, the remainder to total 100 wt % being TFE, and as stated above, may be referred to as MFA.

Typically, the melt-fabricable perfluoropolymer is formed by aqueous dispersion polymerization, wherein the perfluoropolymer is present in the aqueous dispersion as submicrometer-size polymer particles. As in the case of the core/shell polymer described above, the aqueous dispersion of perfluoropolymer can be coagulated to form secondary particles, which in turn can be subjected to melting and the formation into pellets.

The manner of blending of the particulate ETFE containing the submicrometer-size PTFE particles with the melt-fabricable perfluoropolymer will depend on the form of these polymers. For example, aqueous dispersions of the core/shell polymer particles and submicrometer-size particles of melt-fabricable perfluoropolymer can be mixed together without causing coagulation, followed by co-coagulation, wherein the resultant secondary particles contain primary particles of both polymers. The fusion product of these particles will comprise a matrix of melt-fabricable perfluoropolymer copolymer wherein both the submicrometer-size PTFE particles and ETFE are dispersed therein. This fusion product can be obtained by compression molding at a temperature above the melting point of the melt-fabricable perfluoropolymer. Alternatively, the secondary particles can be subjected to melt blending as would occur in such melt-fabrication processes as extrusion and injection molding. For melt blending, the extruder should be suitable for mixing, a twin-screw extruder being particularly suitable for this purpose.

The core/shell polymer additive to the perfluoropolymer is one particulate form of the ETFE. Another particulate form is the coagulum of the core/shell particles dispersed in the polymerization medium. Upon coagulation, these core/shell polymer particles agglomerate, and drying of this agglomerate yields secondary particles, i.e., agglomerates of the core/shell polymer particles (primary particles), the agglomerates generally having an average particle size of about 10 to 400 micrometers. Melt bending of these agglomerates, followed by pelletizing results in pellets being obtained each composed of an ETFE matrix and dispersion of submicrometer-size PTFE particles therein. Typically, such pellets will have a diameter of at least about 3000 micrometers and length of at least 1000 micrometers.

The perfluoropolymer can have the same forms as the core/shell polymer. The composition can be formed by mixing together aqueous dispersions of the core/shell polymer and the perfluoropolymer (wet blending), or by mixing together, the secondary particles of each polymer or by mixing together pellets of each polymer (dry blending). Whether the resultant mixtures are compression molded or melt mixed as occurs in such melt-fabrication processes as injection molding and extrusion, the resultant melt mixture is a dispersion of the submicrometer-size PTFE particles along with the ETFE from the shell of the core/shell polymer in a matrix of the perfluoropolymer. Preferably, the composition contains about 10 to 30 wt %, preferably 15 to 30 wt % of the ETFE and PTFE, based on the total weight of the ETFE, PTFE, and melt-fabricable perfluoropolymer.

The wt % of PTFE core in the core/shell polymer can be varied from predominately PTFE to predominately ETFE as desired, e.g. 1-99 wt % of each polymer, preferably from about 5 to 95 wt %, to total 100 wt % of the core/shell polymer. According to one embodiment of the present invention, the ETFE content of the core/shell polymer is at least about 50 wt %, preferably at least about 60 wt %, the minimum ETFE content being at least about 5 wt % in each case, based on the total weight of the core/shell polymer. The greater the ETFE shell wt %, the smaller will be the amount of core/shell polymer added to the melt-fabricable perfluoropolymer for flex modulus increase.

The PTFE has a flex modulus about the same as that of the melt-fabricable perfluoropolymer, and the ETFE has a flex modulus that is about 2× that of the perfluoropolymer. The improvement in stiffness of the overall composition is much greater than would be predicted from the weighted average of the flex moduli of the ETFE and PTFE blended into the melt-fabricable perfluoropolymer, if it were assumed that the flex modulus of the blend would reflect the flex moduli of all the polymers present.

With respect to the embodiment of the present invention wherein the ETFE is the matrix polymer and is made to have reduced stiffness by dispersion of submicrometer-size PTFE particles therein, this ETFE can be any of the ETFEs described above with respect to the ETFE shell of the core/shell polymer described above. Such ETFE need not perfectly match the ETFE of the shell, but is preferably compatible with the shell ETFE so that when melt mixed together, the two ETFEs are indistinguishable. When the core/shell polymer is melt mixed with the ETFE matrix polymer, the ETFE shell loses its identity within the ETFE matrix, and the resultant composition is essentially of the dispersed submicrometer-size PTFE particles and ETFE matrix derived from the matrix polymer and the ETFE shell. The forms of the core/shell polymer and the ETFE matrix polymer to be mixed together to form composition (a) can be the same as described above with respect to the stiffening of melt-fabricable perfluoropolymer (composition (b)).

Instead of the additive to the ETFE to reduce its stiffness being core/shell polymer as the starting point, the PTFE and ETFE components of the core/shell polymer can be separately polymerized, followed by mixing the resultant aqueous dispersions together, followed by co-coagulation, whereby the resultant dried secondary particles (average particle size of 10 to 400 micrometers) each consist of primary particles of both polymers. Melt mixing of these secondary particles together provides an additive form similar to that of the melt mixing of core/shell polymer, namely a matrix of ETFE within which submicrometer-size particles of PTFE are dispersed. One melt-mixed form of the ETFE/PTFE additive to the ETFE matrix will be in such particulate form as pellets obtained by melt extrusion of the blend of ETFE and PTFE. The average particle size of the PTFE is the same as described above with respect to the PTFE core of the core/shell polymer.

The formation of the composition of the ETFE matrix polymer and the ETFE/PTFE additive can be by the same methods as described above with respect to the ETFE/PTFE/perfluoropolymer composition. Thus, the ETFE matrix polymer can be blended with ETFE and PTFE either as core/shell polymer or mixed dispersions, all as mixed dispersions, followed by co-coagulation and drying to form secondary particles containing both primary particles of either the core/shell polymer or the mixture of ETFE and PTFE primary particles and primary particles of the ETFE matrix, or as mixed secondary particles, some containing only primary particles of either core/shell polymer or separate primary particles of PTFE and ETFE, and others containing only primary particles of ETFE matrix polymer. These mixtures can be processed to fused articles the same as described above. Alternatively, the core/shell polymer or blend of ETFE and PTFE secondary particles may be first pelletized and then melt blended with pelletized ETFE. For efficient blending of pellets a twin screw extruder fitted for good mixing is preferred.

The reduced stiffness ETFE composition, however the PTFE/ETFE additive is formed, will generally comprise about 0.5 to 10 wt % of the PTFE particles and 99.5 to 90 wt % ETFE, based on the combined weight of these two polymers.

The wt % of PTFE core in the core/shell polymer can be varied from predominately PTFE to predominately ETFE as desired, e.g. 1-99 wt % of each polymer, preferably from about 5 to 95 wt %, to total 100 wt % of the core/shell polymer. The greater the PTFE core wt %, the smaller will be the amount of core/shell polymer added to the ETFE for flex modulus reduction, to result in the PTFE particles dispersed in the ETFE matrix being from about 0.5 to 10 wt % based on the combined weight of the PTFE and the ETFE matrix, i.e. ETFE from the shell of the core/shell polymer plus the ETFE to which the core/shell polymer was added. Preferably, the ETFE content of the shell of the core/shell polymer is such that this ETFE forms no more than 25 wt % of the ETFE matrix. These compositional aspects also apply to separate aqueous dispersions of ETFE and PTFE as the starting point for the additive to the matrix ETFE.

The ETFE matrix polymer (shell polymer) is a tough copolymer, having a tensile strength greater than that of melt-fabricable perfluoropolymer, e.g. a tensile strength of at least 30 MPa, preferably at least 35 MPa and elongation of at least about 280%. The copolymer also has a high flex modulus of at least about 1150 MPa, sometimes even greater than 1300 MPa. The practice of the present invention reduces this flex modulus considerably, at least 20% reduction in flex modulus, without sacrifice in elongation. ETFE does not adhere to PTFE when heated in contact with one another above the PTFE melting point and then cooled, indicating the incompatibility of these polymers. Thus, it is surprising that incorporation of the PTFE particles into the ETFE matrix reduces the flex modulus of the ETFE, making it more flexible.

### EXAMPLES

LOI is determined in accordance with the procedure of ASTM D 2863-06a, Procedure A/Test Method A on plaques molded from the test polymer, the plaques measuring 5 in×¼ in×⅛ in and being conditioned at 23° C. and 55% relative humidity for 88 hr just prior to test. Test polymer made of PTFE by itself exhibits an LOI of 95. Test polymer of the ethylene/fluoroethylene polymer by itself exhibits an LOI of 30 to 31. The calculated LOI for the core/shell polymer is obtained by application of the rule of mixing. Sample calculation (for Example 1): 12.6 wt % core having LOI of 95+87.4 wt % shell having an LOI of 31=LOI of 39

Average particle size (diameter), referred to herein is the RDPS (raw dispersion particle size) as determined by the laser light scattering method of ASTM D4464.

The flex modulus is determined at 23° C. in accordance with ASTM D-790 on compression molded plaques formed by the following procedure: The blend of matrix polymer powder and core/shell polymer powder is compressed under a force of 20,000 lbs (9070 kg) at a temperature of 350° C. to make 6×6 in (15.2×15.2 cm) compression moldings. In greater detail, to make the 60 mil thick plaque, the powder blend is added in an overflow amount to a chase which is 55 mil (1.4 mm) thick. The chase defines the 6×6 in sample size. To avoid sticking to the platens of the compression molding press, the chase and powder filling are sandwiched between two sheets of aluminum foil. The press platens are heated to 350° C. This sandwich is first pressed for 5 min at about 200 lb (91 kg) to melt the polymers of the powder blend and cause it to coalesce, followed by pressing at 10,000 lb (4535 kg) for 2 min, followed by 20000 lb (9070 kg) for 2 min, followed by release of the pressing force, removal of the compression molding from the chase and sheets of aluminum foil, and cooling in air under a weight to prevent warping of the plaque.

The elongation (at break) is determined by the procedure of ASTM D 638-03 on dumbbell-shaped test specimens 15 mm wide by 38 mm long and having a web thickness of 5 mm, stamped out from 60 mil (1.5 mm) thick compression molded plaques.

### Example 1

Polymerization is carried out in a stirred pressure vessel 10 gallons (40 liters) in capacity. Before use, the vessel is charged with 44 lbs (20 kg) of demineralized water, 5 g of ammonium persulfate, and 80 ml of a 20 wt % solution of ammonium perfluorooctanoate in water. The vessel is brought to a boil (100° C.) for 30 minutes. The contents are discharged.

The precharge for polymerization is:
Demineralized water, 40 lbs (18 kg);
Krytox® 157 FSL perfluoropolyether acid, 2 g;
Oxalic acid, 1.0 g;
Potassium metabisulfite, 0.2 g;
Succinic acid, 1.0 g;
Ammonium perfluorooctanoate, 300 ml of 20 wt % solution in water.

Initiator for the polymerization is potassium permanganate, 7.2 g with ammonium phosphate 1 g, per liter of demineralized water.

The vessel is charged with TFE, 10-15 psig (172-207 kPa) at 50° C., and evacuated. This is repeated twice so as to displace oxygen. The precharge is added, and then TFE is added to bring the pressure to 225 psig (1.65 MPa). Agitation (44 rpm) is begun. Initiator solution, 50 ml, is added at 50 ml/min, then 1 ml/min initiator solution addition is begun. Polymerization is considered to begin when vessel pressure has dropped 10 psi (70 kPa), at which point pressure is restored to 225 psig (1.65 MPa). Temperature of the vessel contents is controlled at 50° C., TFE feed is set at 0.06 lbs/min (27 g/min). The vessel is vented if necessary to maintain pressure at no more than 225 psig (1.65 MPa). After 15 minutes (core time), pressure is 150 psig (1.14 MPa) agitation is stopped and TFE and initiator solution feeds are stopped. The vessel is vented and evacuated, and cooled to 25° C. This completes the formation of the PTFE core.

The vessel is then charged with ethane to 8 inches Hg (27 kPa). The vessel is heated to 50° C. and charged with ethylene to increase pressure by 25 psi (170 kPa) and then add TFE to increase pressure to 225 psig (1.65 MPa). Begin agitation (44 rpm). Establish flow of ethylene to the vessel at 0.017 lb/min (7.7 g/min) and TFE at 0.06 lbs/min (27 g/min), venting if necessary to maintain pressure at 225 psig (1.65 MPa). These feeds of ethylene and TFE provide an ETFE copolymer having an ethylene and TFE content each of about 50 mole %. Inject 20 ml perfluoro(ethyl vinyl ether) (PEVE). Add 100 ml of initiator solution at 50 ml/min and then feed initiator solution at 2 ml/min. Polymerization is considered to begin when vessel pressure has dropped 10 psi (70 kPa), at which point pressure is restored to 225 psig (1.65 MPa) with TFE.

Maintain temperature at 50° C. and begin PEVE feed at 0.9 ml/min. Continue polymerization for 220 minutes (shell time), then stop agitation, vent the vessel, and drain the contents. The weight of the resulting dispersion is 53.4 lbs (24 kg) and 22.3% solids. From monomer consumption, the core is found to be 12.6 wt % and the shell 87.4 wt % of the core/shell polymer. The RDPS of the PTFE core is 38 nm and the RDPS of the core/shell polymer is 76 nm. The LOI measured for the core/shell polymer is 44, as compared to the calculated LOI of 39.

### Example 2

Example 2 follows the procedure of Example 1 except that the core time is 5 minutes, and the shell time is 170 minutes. The resulting dispersion is 17% solids and the core is found to be 5.9 wt %, the shell being 94.1 wt % of the core/shell polymer. The RDPS of the core is 26 nm, and the RDPS of the core/shell polymer is 68 nm. The LOI measured for the core/shell polymer is 37.4 as compared to 34.7 for the calculated value.

### Example 3

Polymerization is carried out in a stirred pressure vessel 10 gallons (40 liters) in capacity. Before use, the vessel is charged with 44 lbs (20 kg) of demineralized water, 5 g of ammonium persulfate, and 80 ml of a 20 wt % solution of ammonium perfluorooctanoate in water. The vessel is brought to a boil (100° C.) for 30 minutes. The contents are discharged.

The precharge for polymerization is:
Demineralized water, 40 lbs (18 kg);
Krytox® 157 FSL perfluoropolyether acid, 2 g;
Oxalic acid, 1.0 g;
Potassium metabisulfite, 0.2 g;
Succinic acid, 1.0 g;

Ammonium perfluorooctanoate, 300 ml of 20 wt % solution in water.

Initiator for the polymerization is potassium permanganate, 7.2 g with ammonium phosphate 1 g, per liter of demineralized water.

The vessel is charged with TFE, 10-15 psig (172-207 kPa) at 50° C., and evacuated. This is repeated twice so as to displace oxygen. The precharge is added, and then TFE is added to bring the pressure to 225 psig (1.65 MPa). Agitation (44 rpm) is begun. Initiator solution, 50 ml, is added at 50 ml/min, then 1 ml/min initiator solution addition is begun. Polymerization is considered to begin when vessel pressure has dropped 10 psi (70 kPa), at which point pressure is restored to 225 psig (1.65 MPa). Temperature of the vessel contents is controlled at 50° C., TFE feed is set at 0.06 lbs/min (27 g/min). The vessel is vented if necessary to maintain pressure at no more than 225 psig (1.65 MPa). After 30 minutes (core time), pressure is 109 psig (0.85 MPa) agitation is stopped and TFE and initiator solution feeds are stopped. The vessel is vented and evacuated, and cooled to 25° C. This completes the formation of the PTFE core.

The vessel is heated to 50° C. and charged with ethylene to increase pressure by 25 psi (170 kPa) and then add TFE to increase pressure to 225 psig (1.65 MPa). Begin agitation (44 rpm). Establish flow of ethylene to the vessel at 0.017 lb/min (7.7 g/min) and TFE at 0.06 lbs/min (27 g/min), venting if necessary to maintain pressure at 225 psig (1.65 MPa). Inject 20 ml perfluoro(ethyl vinyl ether) (PEVE). Add 100 ml of initiator solution at 50 ml/min and then feed initiator solution at 2 ml/min. Polymerization is considered to begin when vessel pressure has dropped 10 psi (70 kPa), at which point pressure is restored to 225 psig (1.65 MPa) with TFE. Maintain temperature at 50° C. and begin PEVE feed at 0.9 ml/min. Continue polymerization for 90 minutes (shell time), then stop agitation, vent the vessel, and drain the contents. The resulting dispersion is 18.66% solids. From monomer consumption, the core is found to be 27.3 wt % and the shell 72.7 wt % of the core/shell polymer. The RDPS of the core is less than 50 nm and of the core/shell polymer is 83 nm. The measured LOI for this core/shell polymer is 62 as compared to 49 for the calculated value.

### Example 4

The procedure of Example 3 is repeated with the following changes: In the formation of the PTFE core (step (a)), the pressure is 104 psig (0.82 MPa) when agitation and monomer and initiator feeds are stopped. In the formation of the copolymer shell, the modifying monomer used is perfluorobutyl ethylene (PFBE) instead of PEVE and the polymerization vessel is then charged with ethane to 16 inches Hg (54 kPa). The resulting dispersion is 15.12 wt % polymer solids of which the core content is 35.2 wt % and the shell is 64.8 wt % of the core/shell polymer formed. The PFBE content of the copolymer shell is about 4 wt %.

For each of the Examples, the polymerizations were discontinued for economy of time. The aqueous dispersions obtained were free of coagulum.

### Example 5

### Reducing the Flex Modulus of ETFE

The ETFE used in this Example is a copolymer of equimolar amounts of ethylene and TFE, the copolymer also containing about 4 wt % copolymerized PFBE. This ETFE is in the form of secondary particles (powder). This ETFE by itself exhibits a flex modulus of 1320 MPa and an elongation of 317%.

The ETFE of the preceding paragraph (matrix polymer) is dry blended with the core/shell polymer of Example 1 in the following proportions: 10 wt % core/shell polymer and 90 wt % matrix polymer. The amount of PTFE in this dry blend is about 3 wt %. The flex modulus of this blend is 855 MPa and its elongation is 454%

In another experiment, the matrix polymer is dry blended with the core/shell polymer of Example 1 in the following proportions: 25 wt % core/shell polymer and 75 wt % matrix polymer. The amount of PTFE in this blend is about 8 wt %. The flex modulus of this blend is 885 MPa and its elongation is 445%.

### Example 6

### Increasing the Flex Modulus of Perfluoropolymer

The perfluoropolymer used in this Example is a copolymer of TFE with 3.8 wt % PPVE having an MFR of about 14 g/10 min and is in the form of secondary particles (powder) having an average size of about 15 micrometers. By itself, this polymer exhibits a flex modulus of 655 MPa.

This perfluoropolymer (matrix polymer) powder is dry blended with the core/shell polymer of this Example in the following proportions: 25 wt % core/shell polymer and 75 wt % perfluoropolymer. The amount of PTFE and ETFE in this dry blend is 6.8 and 18.2 wt %, respectively, the remainder of the blend to total 100 wt % being the perfluoropolymer.

The flex modulus of this blend is 986 MPa. This is a 50% increase in flex modulus as compared to the perfluoropolymer by itself (calculation: [(986−655)÷655]×100). This increase in flex modulus is much more than could be predicted from the flex moduli of the PTFE and ETFE blended with the perfluoropolymer. For example if the PTFE were taken to have the same flex modulus as the perfluoropolymer, then the expected contribution of the 18.2 wt % ETFE to the flex modulus of the blend can be estimated as follows: (18.2%×1320)+(81.8%×655)=776 MPa for blend, which is an 18.5% increase in flex modulus. The blend exceeds the predicted flex modulus by a factor of 2.7 (50%/18.5%).

Similar unexpected improvement is obtained when FEP is substituted for the TFE/PPVE copolymer as the matrix polymer.

What is claimed is:

1. Composition comprising a matrix of either (a) ethylene/tetrafluoroethylene copolymer or (b) melt-fabricable perfluoropolymer, each containing submicrometer-size particles of polytetrafluoroetheylene therein, with the proviso that ethylene/tetrafluoroethylene copolymer is also contained in perfluoropolymer (b), the composition containing copolymer (a) exhibiting an decrease in flex modulus of at least 20% as compared to said copolymer by itself, the composition containing perfluoropolymer (b) exhibiting an increase in flex modulus of at least 20% as compared to said perfluoropolymer by itself.

2. The composition of claim 1 made by melt mixing of said copolymer (a) or said perfluoropolymer (b) with said polytetrafluoroethylene particles coated with ethylene/tetrafluoroethylene copolymer.

3. The composition of claim 2, wherein said polytetrafluoroethylene particles coated with ethylene/tetrafluoroethylene copolymer are core/shell polymer particles wherein the core is said polytetrafluoroethylene and said shell is said ethylene/tetrafluoroethylene copolymer coated thereon.

4. The composition of claim 3 wherein said polytetrafluoroethylene particles coated with ethylene/tetrafluoroethylene copolymer is a dispersion of said particles in said ethylene/tetrafluoroethylene copolymer as a matrix for polytetrafluoroethylene, thereby forming the coating of ethylene/tetrafluoroethylene copolymer thereon.

5. The composition of claim 1 wherein in composition containing copolymer (a), the amount of said polytetrafluoroethylene is 0.5 to 10 wt % based on the combined weight of said polytetrafluoroethylene and said copolymer (a).

6. The composition of claim 1 wherein in the composition containing perfluoropolymer (b), the amount of said ethylene/tetrafluoroethylene copolymer and said particles of polytetrafluoroethylene is about 10 to 30 wt %, based on the combined weight of said perfluoropolymer, copolymer and polytetrafluoroethylene.

7. Process comprising blending submicrometer-size particles of polytetrafluoroethethylene either into ethylene/tetrafluoroethylene copolymer to reduce the stiffness thereof or together with ethylene/tetrafluoroethylene copolymer into melt-fabricable perfluoropolymer to increase the stiffness thereof.

8. The process of claim 7 wherein said particles of polytetrafluoroethylene blended into said perfluoropolymer to stiffen it are contained within particles of ethylene/tetrafluoroethylene copolymer.

9. The process of claim 7 wherein said particles of polytetrafluoroethylene are the cores of core/shell polymer, said core comprising said polytetrafluoroethylene and said shell comprising ethylene/tetrafluoroethylene copolymer.

10. Ethylene/tetrafluoroethylene copolymer in the form of core/shell polymer, said core being polytetrafluoroethylene and said shell being said copolymer.

11. The copolymer of claim 10 wherein said shell comprises at least 72 wt % of the combined weight of said polytetrafluoroethylene core and said copolymer shell.

12. An aqueous dispersion of the core/shell polymer of claim 10, wherein the average particle size of said polymer is no greater than 125 nm.

13. Melt mixture comprising the core/shell polymer of claim 10.

14. The melt mixture of claim 13, said melt mixture comprising a dispersion of said core as particles in a matrix of said copolymer.
